(19) United States
(12) Patent Application Publication
(10) Pub. No.: US 2026/0197673 A1
(43) Pub. Date: Jul. 9, 2026

(54) Indoor Small Cell Displacement Monitoring

(71) Applicant: DISH Wireless L.L.C., Littleton, CO (US)

(72) Inventor: In-Kyung Kim, Highlands Ranch, CO (US)

(21) Appl. No.: 19/012,507

(22) Filed: Jan. 7, 2025

(51) Int. Cl. H04W 24/02; H04B 17/318; H04W 64/00

(52) U.S. Cl. CPC H04W 24/02; H04B 17/318; H04W 64/006

(57) ABSTRACT

Various arrangement for determining whether an access point has been moved or reoriented are detailed. An on-site small cell installation can be located at a facility of an entity. The installation can include a primary small cell that is configured to communicate, via a wired backhaul connection, with a cellular network core hosted by a cellular network provider. The installation can also include a secondary small cell comprising an inertial measurement unit (IMU). The secondary small cell can be configured to perform movement measurements using the IMU and transmit messages based on the movement measurements to a cellular network core.

### BACKGROUND

Indoor small cells of a cellular network and, more generally, access points (APs) of a wireless network, tend to be discrete devices that can be easily moved and manipulated by a person. Due to their small form factor and relatively demure physical appearance, an uninformed person may not be aware of the importance of the small cell's position and orientation. For example, in order to provide high bandwidth throughput for a cluster of user equipments (UEs), the small cell may be positioned and oriented to increase signal strength with where the UEs are expected to be located. Inadvertent movement or reorientation of the small cell can negatively impact performance and require significant manual investigation to determine the cause of the decreased performance.

### SUMMARY

Various embodiments are described related to a cellular system. In some embodiments, a cellular system is described. The system may comprise an on-site small cell installation located at a facility of an entity. The on-site small cell installation may comprise a primary small cell that may be configured to communicate, via a wired backhaul connection, with a cellular network core hosted by a cellular network provider. The on-site small cell installation may comprise a secondary small cell comprising an inertial measurement unit (IMU), the secondary small cell configured to communicate via a cellular backhaul connection that may use a cellular communication protocol with the primary small cell. Additionally or alternatively, the primary small cell may include an IMU. The secondary small cell and/or the primary small cell may be configured to communicate wirelessly with a plurality of user equipments (UEs) using the cellular communication protocol. The secondary small cell and/or the primary small cell may be configured to perform movement measurements using the IMU. The system may comprise the on-site small cell installation that may be configured to transmit a first message based on the movement measurements to the cellular network core.

Embodiments of such a system may include one or more of the following features: the on-site small cell installation may be configured to measure a signal strength of the cellular backhaul connection and the on-site small cell installation may be further configured to transmit a second message based on the signal strength to the cellular network core. The system may further comprise a position monitoring system and the cellular network core. The position monitoring system may be configured to analyze the first message and the second message. The position monitoring system and the cellular network core may be executed on a cloud computing platform. The position monitoring system may be configured to generate a report that indicates an identifier of the secondary small cell and an indication of movement. The position monitoring system may be configured to generate a report that indicates an identifier of the secondary small cell and an indication of a change in orientation. The system may further comprise a second on-site small cell installation located at a second facility of a second entity comprising a second primary small cell that may be configured to communicate, via a second wired backhaul connection, with the cellular network core hosted by the cellular network provider. The second on-site small cell installation located at a second facility of a second entity may comprise a second secondary small cell comprising a second IMU, the second secondary small cell configured to communicate via a second cellular backhaul connection with the primary small cell. The second secondary small cell may be configured to communicate wirelessly with a second plurality of UEs using the cellular communication protocol. The second secondary small cell may be configured to perform movement measurements using the second IMU. The second on-site small cell installation may be configured to transmit a second message based on the movement measurements using the second IMU to the cellular network core. The cellular communication protocol may be 5G New Radio (NR). The position monitoring system may be configured to build a position model for the secondary small cell over a period of time using data from the first message. The position monitoring system may be further configured to build a position model for the secondary small cell using signal strength data from the second message.

In some embodiments, a method for monitoring indoor small cell displacement is described. The method may comprise performing, by a secondary small cell, movement and orientation measurements. The secondary small cell may be configured to communicate via a cellular backhaul connection that uses a cellular communication protocol with a primary small cell. The secondary small cell may be configured to wirelessly communicate with a plurality of user equipments (UEs) using the cellular communication protocol. The method may comprise transmitting, by the secondary small cell, a message to a cellular network core based on the performed movement and orientation measurements. The method may comprise in response to the message based on the performed movement and orientation measurements, generating, by a position monitoring system hosted with the cellular network core, a report indicative of displacement. The method may comprise transmitting, by the position monitoring system hosted with the cellular network core, the report to an entity mapped to the secondary small cell.

Embodiments of such a method may include one or more of the following features: performing the movement and orientation measurements may comprise measuring a signal strength of the cellular backhaul connection. The method may further comprise analyzing, by the position monitoring system, the message received from the secondary small cell by comparing data from the message with a position model associated with the secondary small cell. The position monitoring system and the cellular network core may be executed on a public cloud computing platform by a cellular network provider. The report may indicate an identifier of the secondary small cell and an indication of a change in orientation. The method may further comprise performing, by a second secondary small cell, movement and orientation measurements. The second secondary small cell may be configured to communicate via a cellular backhaul connection that may use the cellular communication protocol with a second primary small cell. Transmitting, by the second secondary small cell, a second message to the cellular network core based on the performed movement and orientation measurements. The method may further comprise in response to the second message based on the performed movement and orientation measurements, generating, by the position monitoring system hosted with the cellular network core, a second report indicative of displacement. The method may further comprise transmitting, by the position monitoring system hosted with the cellular network core, the report to a second entity mapped to the second secondary small cell. The second entity may be distinct from the entity. The cellular communication protocol may be 5G New Radio (NR). The method may further comprise building, by the position monitoring system, is configured to build a position model for the secondary small cell over a period of time using data from the message. The position model may be built using signal strength data.

In some embodiments, a non-transitory processor-readable medium is described. The medium may comprise processor-readable instructions configured to cause one or more processors of a secondary access point to perform movement and orientation measurements comprising signal strength measurements of a cellular backhaul connection. The secondary access point may be configured to communicate via the cellular backhaul connection that uses a cellular communication protocol with a primary access point and wirelessly with a plurality of user equipments (UEs) using the cellular communication protocol. The medium may comprise processor-readable instructions configured to cause one or more processors of a secondary access point to transmit a message to a cellular network core based on the performed movement and orientation measurements.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of multiple small cells arranged in an indoor environment.

FIG. 2 illustrates an embodiment of a system that includes cellular network core in communication with multiple on-site small cell networks.

FIG. 3 illustrates an embodiment of a block diagram of a small cell.

FIG. 4 illustrates an embodiment of a report that can be provided to an entity-level user of the cellular network.

FIG. 5 illustrates an embodiment of a method for monitoring indoor small cell displacement.

### DETAILED DESCRIPTION

Indoor small cells can function as part of a cellular network, such as a 5G New Radio (NR) cellular network or some other standard (e.g., 6G and beyond), and can provide cellular network coverage for UEs nearby. Access to the small cell may be limited to UEs mapped to a particular cellular network slice or may be generally accessible to any UE registered to use the cellular network. Small cells may be arranged in a mesh network such that one or more small cells function as secondary APs that relay communications with UE to a primary small cell using a wireless backhaul connection. The primary AP is connected, via a wired backhaul connection, with a remote cellular network core.

In embodiments detailed herein, APs, which include small cells, may be equipped with one or more sensors that allow for detection of movement and/or adjustments to orientation. Such APs can use sensors such as accelerometers, gyroscopes, and global navigation satellite system (GNSS) sensors to determine whether movement and/or a change in orientation has occurred. Additionally or alternatively, variances in signal strength, such as a change in a wireless backhaul connection between a secondary AP and a primary AP can be used to identify movement or orientation changes.

Components of the cellular network maintained off-site coordinate analysis, and reporting of changes in movement, orientation, or both with the entity on whose behalf the small cell is operated. Such components can be integrated with the cellular network core, which can be operated in a cloud-computing environment, operated by the cellular network provider. Therefore, while the small cell may be deployed at a private facility (e.g., an office building, a factory, a stadium, a warehouse, a campus) of an entity (e.g., company, government, organization, private party), monitoring for movement of the small cell is performed by the cellular network operator centrally for multiple entities. The entity can then receive a report of movement for their one or more small cells. Such an arrangement allows entity-level users of a cellular network to monitor their small cells without having to manage any additional hardware or software to do so.

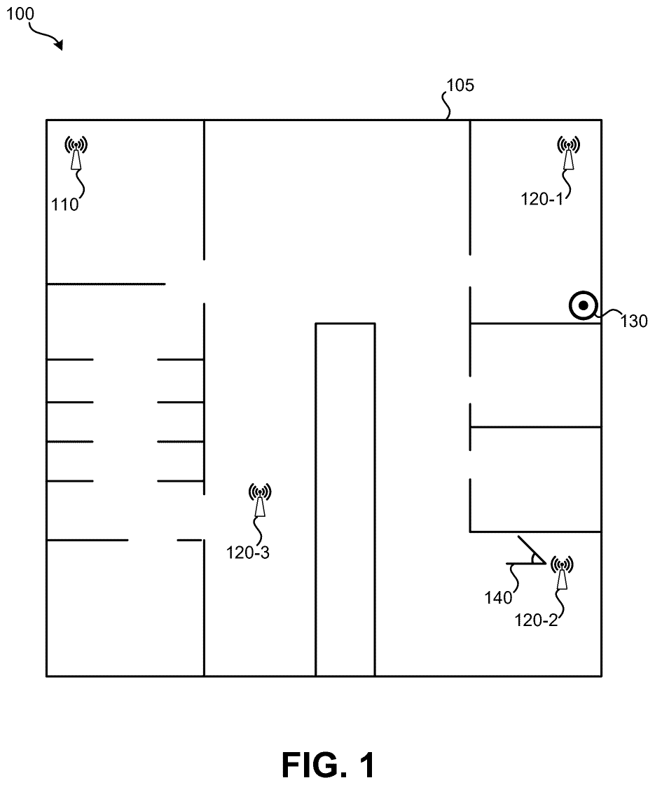

Further detail is provided in relation to the figures. FIG. 1 illustrates an embodiment of a system 100 of multiple APs arranged in an indoor environment. System 100 includes primary AP 110 and multiple secondary APs 120. APs can be small cell devices that provide cellular network access, such as 5G New Radio (NR) cellular network access. Other cellular network standards may be used, such as 4G, 6G, and beyond. As an example, a cellular network may include many base stations scattered over a large geographic area. To complement the network, small cells may be deployed in environment 105 to provide improved cellular network coverage, such as in an indoor environment. Therefore, a cellular communication protocol, such as 5G NR or beyond (e.g., 6G), can be used for wireless communication with the small cells. Alternatively, system 100 can use some other form wireless communication protocol; in some embodiments, a wireless local area network communication protocol is used, such as WiFi.

Each of secondary APs 120 is in wireless communication with primary AP 110 either directly or via a mesh network (e.g., AP 120-2 relaying communications to primary AP 110 via AP 120-3). AP 110 and APs 120 may be arranged in an indoor environment in order to provide wireless network coverage throughout environment 105. As an example, environment 105 can be an office, building, factory, warehouse, school, mall, or some other form of indoor environment in which multiple UEs are to perform wireless network communications. The UEs may be any form of computerized device that is to communicate with the wireless network formed by system 100. Such UEs can be: smartphones; gaming devices; Internet-of-Things (IoT devices); cellular modems; sensors; factory equipment; unmanned aerial vehicles (UAVs); computers; etc.

Primary AP 110 has a wired connection to a network that permits access to a cellular network core hosted offsite by a cellular network operator. The access points of system 100 are maintained and operated by the entity (e.g., owner, corporation) that maintains environment 105, which is distinct from the cellular network and cellular network provider. Therefore, while primary AP 110 and secondary APs 120 function as part of a cellular network, the entity operating in environment 105 is responsible for the positioning and orientation of primary AP 110 and secondary APs 120.

A cellular backlink may be used between each of secondary APs 120 and primary AP 110. Additionally or alternatively, a mesh arrangement in which a secondary AP uses a cellular backlink to another secondary AP which is then relayed to primary AP 110 may be used. Bandwidth of the cellular backlink may be significantly dependent on the signal strength between the APs involved in the backlink. In some embodiments, the beam pattern of an APs antennas can result in one or more directions having significantly lower gain than other directions, such as in the azimuthal plane. For example, rotation of an AP by 45° in the azimuthal plane may result in the gain of an AP's antenna in the direction of the other AP dropping significantly (e.g., 3 dB) resulting in lower bandwidth being available for transferring data.

AP 110 and each of APs 120 may be small devices that can be handheld and are easily manipulated by a person. APs 120 may receive power from an outlet (or hardwired electrical connection) but may be otherwise wireless. Thus, repositioning or reorientation by a person may be easily performed. For example, AP 120-1 may be moved by a person to location 130. From the person's point of view, this may be performed to free up an outlet or to make room for other equipment, however significant adverse effects on system 100 may not be readily apparent to the person. As another example, AP 120-2 may be rotated by some angle either intentionally or inadvertently represented by angle 140. This reorientation may also have significant adverse effects on system 100 by affecting a coverage area of AP 120-2 and/or a backhaul connection with AP 110.

While system 100 shows three secondary APs 120, in other embodiments, greater or fewer numbers of secondary APs 120. In some embodiments, no secondary APs may be present. Environment 105 is merely representative, and the specific environment and the positioning and orientation of the APs is the environment will vary significantly by embodiment. Further, while environment 105 is an indoor environment, small cells or other forms of APs may be arranged in an outdoor or mixed indoor and outdoor environment. For example, small cells may be arranged across a business or college campus or a military base to provide cellular network access inside and outside of buildings.

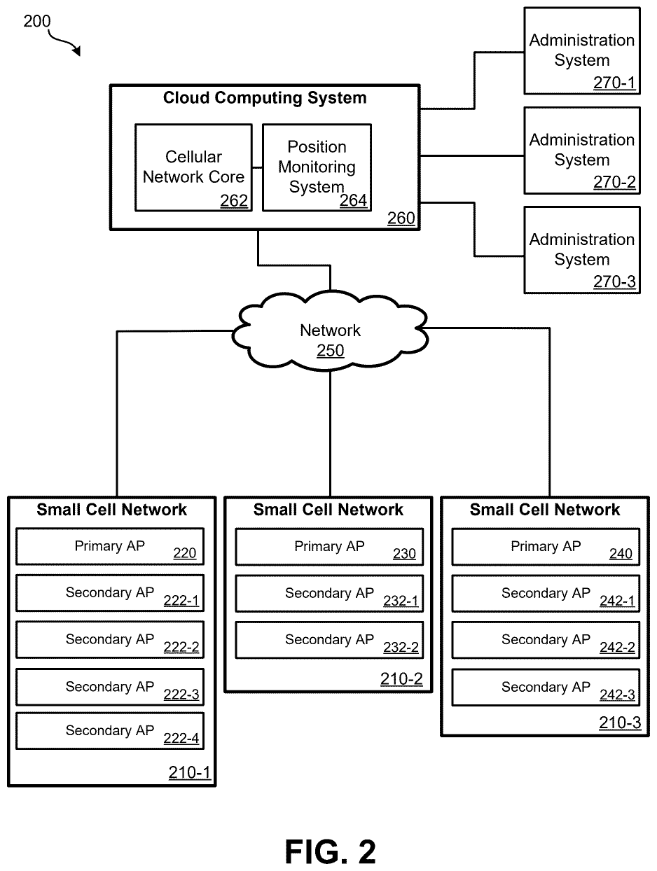

FIG. 2 illustrates an embodiment of a system 200 that includes a cellular network core in communication with multiple on-site small cell networks. System 200 can include: small cell networks 210 (210-1, 210-2, 210-3); network 250; cloud computing system 260; and administrator systems 270 (270-1, 270-2, 270-3). System 100 can be an example of a small cell network, such as small cell network 210-3.

Each of small cell networks 210 can be located at the facilities of distinct entities in different geographic locations. For example, the entity for which small cell network 210-1 is operated is unrelated to the entity for which small cell network 210-2. Continuing with the example, small cell network 210-1 may provide cellular network access within one or more college campus buildings while small cell network 210-2 may provide cellular network access within a factory. Within each small cell network of small cell networks 210-1, a primary AP is present (e.g., primary AP 220 in small cell network 210-1, primary AP 230 in small cell network 210-2, and primary AP 240 in small cell network 210-3). While three small cell networks 210 are illustrated, this number is for example purposes only; fewer or greater numbers of small cell networks 210 can be present in other embodiments. In communication with each primary AP of each small cell network is some number of secondary APs. The number of secondary APs varies by small cell network. For example, four secondary APs are present in small cell network 210-1; two secondary APs are present in small cell network 210-2; and three secondary APs are present in small cell network 210-3. Via their respective primary APs, each of small cell networks 210 are connected with cloud computing system 260 via one or more networks, such as network 250. Network 250 can represent a private high-bandwidth network operated by an Internet Service Provider (ISP) and/or a public network, such as the Internet.

A cellular network slice is a virtualized and logically isolated segment of a physical mobile network infrastructure, tailored to meet the specific needs and requirements of a particular application, service, or group of users (e.g., the UE associated with a particular entity). A cellular network slice is a technology that allows for the creation of multiple, independent virtual networks on a shared physical network infrastructure. Each network slice can have its own unique configuration, performance characteristics, and quality of service (QoS) parameters.

Small cell networks 210 may or may not be restricted based on cellular network slices. For example, an end-user of a cellular network may be able to access any of small cell networks 210. Alternatively, one or more of small cell networks 210 may be restricted such that access is required to a particular cellular network slice particular to the entity at whose facility the small cell network is located. For example, a cellular network slice may be defined to provide a particular QoS for equipment operating in a factory at which small cell network 210-2 is located.

The core of the cellular network can be hosted on a cloud computing platform. Cellular network core 262 can be hosted on cloud computing system 260. Cellular network core 262 can function in coordination with various other components of a cellular network in order to provide cellular network access to UEs. For example, distributed unit (DU) functionality may be performed direction at the components of a small cell network; centralized unit (CU) functionality may reside at an edge server system in communication with the small cell networks.

Cellular network core 262 can be physically distributed across data centers or located at a central national data center (NDC) on cloud computing system 260 and can perform various core functions of the cellular network. Cellular network core 262 can include components such as: network resource management components; policy management components; subscriber management components; and packet control components. Individual components may communicate via a bus, thus allowing various components of cellular network core 262 to communicate with each other directly. Other embodiments can involve additional components.

Network resource management components can include multiple network functions (NFs): Network Repository Function (NRF) and Network Slice Selection Function (NSSF). The NRF can allow 5G NFs to register and discover each other via a standards-based application programming interface (API). The NSSF can be used by the AMF to assist with the selection of a network slice that will serve a particular UE. Policy management components can include: Charging Function (CHF) and Policy Control Function (PCF). CHF allows charging services to be offered to authorized network functions. Converged online and offline charging can be supported. PCF allows for policy control functions and the related 5G signaling interfaces to be supported.

Subscriber management components can include: Unified Data Management (UDM) and Authentication Server Function (AUSF). UDM can allow for generation of authentication vectors, user identification handling, NF registration management, and retrieval of UE individual subscription data for slice selection. AUSF performs authentication with UEs. Packet control components can include: Access and Mobility Management Function (AMF) and Session Management Function (SMF). AMF can receive connection-and session-related information from UEs and is responsible for handling connection and mobility management tasks. SMF is responsible for interacting with the decoupled data plane, creating updating and removing Protocol Data Unit (PDU) sessions, and managing session context with the User Plane Function (UPF).

User plane function (UPF) can be responsible for packet routing and forwarding, packet inspection, quality of service (QoS) handling, and external PDU sessions for interconnecting with a Data Network (DN) (e.g., the Internet) or various access networks. Therefore, access to the Internet by a UE communicating with either a primary AP or secondary AP of one of small cell networks 210 may be routed via cellular network core 262 to the Internet.

Cloud computing system 260 may be a private or public cloud computing system. If private, cloud computing system 260 is maintained exclusively for the use of the cellular network. In such embodiments, the cellular network provider can operate distributed hardware to provide a private cloud computing environment to host components such as cellular network core 262.

In other embodiments, cloud computing system 260 is hosted on a public cloud computing system. A public cloud computing platform is a type of cloud computing environment where a third-party provider makes computing resources, such as servers, storage, and applications, available to the general public via the Internet or via a private network connection. These platforms are designed to provide scalable and flexible resources that can be used on a pay-as-you-go basis. A key concept of a public cloud computing platform is multi-tenancy: multiple users (or “tenants”) are mapped to distinct accounts and share the same underlying physical infrastructure, which optimizes resource utilization and reduces costs. Another key concept of a public cloud computing platform is scalability. Public cloud platforms offer expansive and rapid scalability, allowing users to easily increase or decrease their computing resources based on demand. Each user's data is maintained distinct from each other. In system 200, the cellular network provider would function as one user that has an account through which cellular network core 262 is operated on the public cloud computing platform while other unrelated user's data is also stored and processed by the public cloud computing platform. Amazon Web Services (AWS) is an example of a public cloud computing platform.

In communication with cellular network core 262 can be position monitoring system 264. Position monitoring system 264 can perform multiple functions, including: 1) determine when an AP functioning as part of a small cell network 210 has been moved, reoriented, or both; 2) build a model indicative of the AP's position and orientation; and 3) cause a report to be provided to an administrator mapped to the entity that uses the small cell network of which the AP is a part.

In some embodiments, raw inertial measurement unit (IMU) data, signal strength data, and/or global navigation satellite system (GNSS) data is transmitted by APs to position monitoring system 264. GNSS can be particularly useful in detecting movement (but not orientation) when APs are deployed outdoors; when indoors, an insufficient signal strength may be present in order to make GNSS measurements. When an AP is deployed indoors, if a GNSS signal cannot be detected for a defined period of time, the GNSS sensor may be disabled. In such embodiments, position monitoring system 264 analyzes the received data to determine if an individual AP has moved or been reoriented sufficiently to warrant a notification being provided to an administrator of an entity which uses the corresponding small cell network. In some embodiments, IMU data, GNSS data, and/or signal strength data can be compared with defined thresholds to determine whether an AP has been moved or reoriented. For IMU data and GNSS data, fixed thresholds may be used. For signal strength data, a threshold defined based on average signal strength may be calculated.

In some embodiments, one or more proximity sensors may be used to determine where an AP is located in relation to surfaces and walls. When changes are detected by the one or more proximity sensors, a determination can be made that the AP has been moved or reoriented. For example, if an AP is attached to a wall or ceiling, if the AP is detached, this change can be detected immediately by the AP using the proximity sensor measurements.

In other embodiments, movement or reorientation is determined directly by each AP. In such embodiments, an AP monitors movement and reorientation based on IMU data, signal strength data, and/or GNSS data. In such embodiments, IMU data, GNSS data, and/or signal strength data can be compared with defined thresholds to determine whether an AP has been moved or reoriented. For IMU data and GNSS data, fixed thresholds may be used. For signal strength data, a threshold defined based on average signal strength may be calculated. If movement or reorientation is detected, a message can be transmitted to position monitoring system 264 via cellular network core 262. For example, position monitoring system 264 can be communicated with by an AP via the UPF operating as part of cellular network core 262.

In some embodiments, a model is built by position monitoring system 264 for each AP. To create the model, signal strength measurements can be used determine a baseline location for the AP. The baseline model may include variations in signal strength that occur in some form of pattern. For example, in a factory environment, operating equipment may cause a significant increase in signal interference thus causing the signal strength to decrease. The times at which this interference occurs may be factored in to the model to attempt to distinguish reorientation or movement from interference originally from some other source. Once the baseline has been created, future received signal strength measurements can be compared with the created model that takes additional factors, such as time of day, into account to determine whether the AP has likely been moved or reoriented. For example, due to changing interference conditions while factory equipment is in operation, the model may be used to assess whether the AP has been moved after business hours (e.g., using signal strength measurements taken during the time period of 1-4 AM).

Position monitoring system 264 can coordinate a report being provided to an administrator indicative of movement of an AP mapped to a particular entity. As previously noted, each small cell network can be operated at a facility of a particular entity (e.g., company, school, government agency). While the cellular network is operated by a cellular network provider, positioning and maintenance of access points may be the responsibility of the entity at whose facility the APs are located. An administrator or administration system may be mapped to each small cell network. For example, administration system 270-1 may be mapped to small cell network 210-1, administration system 270-2 may be mapped to small cell network 210-2, and administration system 270-3 may be mapped to small cell network 210-3.

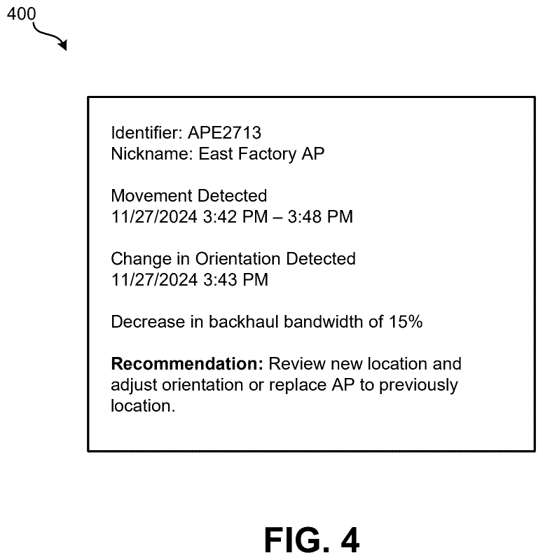

A report, such as detailed in relation to FIG. 4, can be transmitted to an administration system of administration system 20 to indicate that movement of an AP has likely happened. Position monitoring system 264, in response to determining an AP has likely moved, can determine the administration system associated with the moved or reoriented AP and cause a report to be transmitted to the administration system. For example, administration system 270-1 may be on-site at the same facility as small cell network 210-1. The transmitted report can enable a representative of the entity to address the issue, such as by repositioning the AP that was previously moved or reoriented.

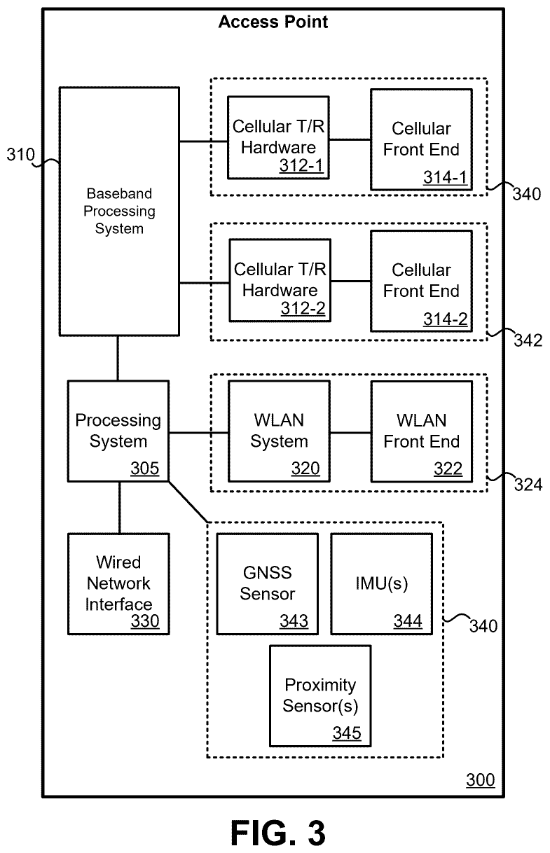

FIG. 3 illustrates an embodiment of a block diagram of AP 300. AP 300 can be classified as a small cell since it provides cellular network access. AP 300 can include: processing system 305; baseband processing system 310; cellular transmit and receive (T/R) hardware 312; cellular front ends 314; WLAN system 320; WLAN front end 322; and wired network interface 330. Embodiments of AP 300 can function as a primary or secondary AP.

Processing system 305 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as random access memory (RAM), flash memory, a hard disk drive (HDD), or a solid state drive (SSD).

Processing system 305 may handle interfacing with the cellular network core 150, such as through a wired network interface when AP 300 is functioning as a primary AP. Processing system 305 can provide management functions, including: routing the cellular traffic to cellular network core 150; routing WLAN traffic directly to the Internet; routing IMS voice (VoNR) to cellular network core 150; in some arrangements, routing all traffic (i.e., cellular and WLAN communications) to cellular network core 262; configuring and managing secondary APs; managing gNodeB to gNodeB interfacing; self-organizing network (SON) functionality; and spectrum management handling (e.g., spectrum access system (SAS) and automated frequency coordination (AFC) handling for unlicensed/shared spectrum management).

A cellular interface can include baseband processing system 310, cellular T/R hardware 312, and cellular front ends 314. Baseband processing system 310 may be a system on a chip (SOC) or multi-chip system that serves to perform cellular-specific computing, such as signal processing, modulation and demodulation, error correction, filtering, frequency conversion and various access techniques (e.g., code division multiplex access). Baseband processing system 310 can include a lower layer processing unit that utilizes special-purpose hardware acceleration (e.g., a purpose-designed ASIC). Baseband processing system 310 can also include an upper level processing unit that is implemented using one or more general purpose processors. Baseband processing system 310 can perform execution of algorithms that include channel estimation, modulation, demodulation, and forward error correction (FEC). Accordingly, baseband processing system 310 can translate data into and out of a digital form specific for transmission on a 5G NR network.

Processing system 112 may perform functionality including prioritization and gNodeB functionality. For example, processing system 112 may function as a DU and, possibly, provide CU functionality for UE wirelessly communicating with AP 300. As an example of DU functionality that is provided, scheduler functions are implemented locally to allow for the proper scheduling of communications with UE. Processing system 112 can also perform communication prioritization, such as, according to the slice UE, are assigned to and according to whether the UE is using cellular or a WLAN communication protocol.

Cellular T/R hardware 312 serves to convert between digital data and RF. Digital data is received by cellular T/R hardware 312-1 and is output as RF to cellular front end 314-1. RF is received by cellular T/R hardware 312-1 from cellular front end 314-1 and converted to digital data for baseband processing system 310.

Cellular front ends 314 can include multiple amplifiers, mixers, and antennas used to transmit and receive RF. Cellular front end 314-1 can be used for a multiple input, multiple output (MIMO) arrangement allowing for multiple transmissions or multiple receptions of RF simultaneously. For example, cellular front end 314-1 can include four antennas and associated hardware. Cellular front end 314-1 can allow for a 4×4 transmit/receive arrangement on 100 MHz of bandwidth. Cellular front end 314-2 can include similar hardware.

AP 300 may directly communicate with UE and may also have one or more cellular backhaul communication channels with one or more other APs. For example, if AP 300 is functioning as a primary AP, it may have a wireless backhaul connection with one or more secondary APs. If AP 300 is a secondary AP, it may have a wireless backhaul connection with a primary AP. Separate hardware and/or spectrum may be used for each of these uses. For example, RF unit 340 may be used exclusively for communication with UE by providing gNodeB functionality to such UE, while RF unit 342 may be used exclusively for cellular backhaul communications with another access point.

One key differentiator between WLAN communications and cellular is that cellular uses reserved spectrum that is licensed or permitted to a particular cellular network operator. Therefore, in order to perform cellular communications on particular frequency bands, the operator of primary AP 110 must obtain permission to use the spectrum, such as via the cellular network provider that operates cellular network core 262. As an example, a cellular network provider may offer the use of a primary AP and one or more secondary APs as an additional service to its subscribers or partners. Spectrum licensed by the cellular network provider can then be used by the subscribers or partners as part of their service with the cellular network provider. In some embodiments, cellular communications can be performed using unlicensed spectrum. For example, Consumer Broadband Radio Service (CBRS) General Authorized Access (GAA), NR-U (NR unlicensed) using, for example, n96 (6 GHz spectrum) are possible options.

As an example, RF unit 340 may be assigned to use bands n77 (which includes CBRS), n48 for communication directly with UE, while RF unit 342 may be assigned to use bands n96 and/or n46 for cellular backhaul communications. In some embodiments, bands used for communication directly with UE are not also used for backhaul; in other embodiments, spectrum can be shared. For example, bands n96, and/or n46 may also be used for communication directly with UE. The specific spectrum used may be dependent on what spectrum the cellular network operator has a license to use. If AP 300 does not communicate with UE directly (such as a when functioning as a primary AP), RF unit 340 may not be present or may be used for cellular backhaul with secondary APs instead.

When functioning as a primary AP, a wired network interface may be present. A wired network interface can be connected with network 250, which can be operated by an internet service provider or as a private high-speed fiber network. The wired network interface may connect to network 250 via one or more modems or routers.

Optionally present in primary AP 110 are WLAN components 324. WLAN components 324 include WLAN system 320 and WLAN front end 322. WLAN system 320 serves to convert between digital data and RF. WLAN front end 322 can include multiple amplifiers, mixers, and antennas used to transmit and receive RF. WLAN front end 322 can be used for a multiple input, multiple output (MIMO) arrangement allowing for multiple transmissions or multiple receptions of RF simultaneously. For example, WLAN front end 322 can include four antennas and associated hardware.

In communication with processing system 305 can be GNSS sensor 343, one or more inertial measurement units 344 (IMUs), and/or one or more proximity sensor(s) 345. GNSS sensor 343, which may be a global positioning system (GPS) sensor, may be used to determine the position of AP 300. IMUs 344 can include one or more accelerometers and gyroscopes which can be used to determine movement (indicative of a change in location) and orientation. Proximity sensor(s) 345 can be used to measure movement of the AP in relation to objects (e.g., walls, ceiling, surfaces) to identify changes in orientation and position. Processing system 305 can compare measurements taken by GNSS sensor, one or more proximity sensors 345, and/or one or more IMUs 344 with threshold values to assess whether AP 300 has been moved or reoriented. Alternatively, measurements may be transmitted to position monitoring system 264 to determine if movement or a change in orientation has occurred.

Signal strength measurements taken for a backhaul communication channel, such as using RF unit 342, can be used to determine if movement or a change in orientation has occurred. Processing system 305 may periodically or occasionally make signal strength measurements of the wireless backhaul connection. The signal strength measurements may be compared with a locally stored value, which may be based on some number of previous measurements or the signal strength measurements may be transmitted to position monitoring system 264 for analysis.

FIG. 4 illustrates an embodiment of a report 400 that can be provided to an entity-level user of the cellular network. If an AP is moved, report 400 can be transmitted, such as in the form of an email or pop-up notification on a smart device, that indicates a movement (e.g., a change in position) and/or a change in orientation. A timestamp can be included with the indication of the change. In some embodiments, additionally or alternatively, a change in location or orientation can be noted based on a measured change in signal strength, such as more than a defined threshold difference (e.g., increase or decrease) from a measured average value. Included as part of report 400 can be a recommendation. The recommendation may indicate whether the orientation, location, or both needs to be adjusted. If the change in orientation or location was intentional, a user may be permitted to respond as such or ignore report 400.

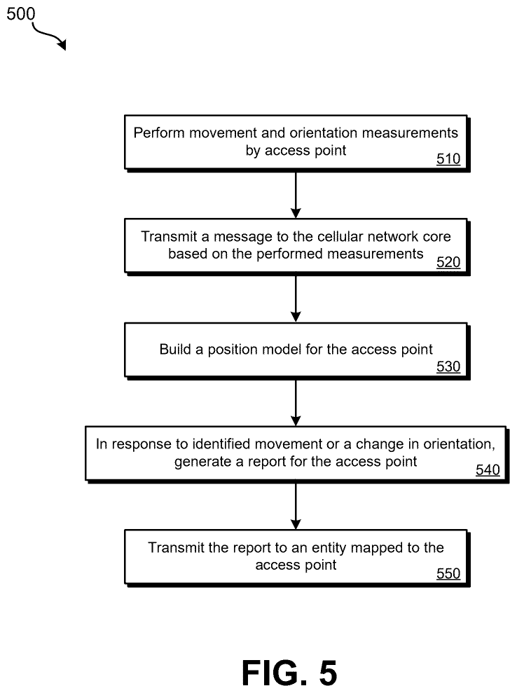

Various methods can be performed using the systems and arrangements of FIGS. 1-4. FIG. 5 illustrates an embodiment of a method 500 for monitoring indoor small cell displacement. Displacement can refer to a change in location, orientation, or both. Method 500 can be performed using systems 100 and 200, which can include the use of one or more APs as detailed in relation to AP 300.

At block 510, an access point or small cell performs movement measurements, orientation measurements, or both using integrated sensors such as accelerometers and gyroscopes. Additionally or alternatively, signal strength measurements are made between the AP and another AP (e.g., between a primary and secondary AP) using a cellular backhaul communication link. Notably, the backhaul link is used for signal strength measurements rather than the communication links with individual UEs because UEs are expected to move and have significantly changing signal strength, whereas the backhaul link is expected to have a relatively stable signal strength due to the APs intending to remain in fixed locations.

At block 520, the access point can transmit a message containing the collected measurement data to the cellular network core and position monitoring system in communication with the cellular network core. This data can be either raw sensor measurements, combined measurements (e.g., average values over time) or data based on measurements. For example, in some embodiments, measurements are compared by the AP locally with a threshold value to determine if movement or a change in orientation occurred. In other embodiments, such an analysis is performed remotely at the position monitoring system.

At block 530, the position monitoring system in communication with the cellular network core can process the received data to construct a position model for the AP, which includes its current position, orientation, and any detected changes from a previous state. The model may be particularly useful in combination with signal strength measurements. For example, at particular times of day or days of the week, the signal strength may be expected to decrease due to interference rather than movement or a change in orientation. The model can account for changes in signal strength for different times of the day or days of the week to prevent such a decrease in signal strength from being inaccurately labeled as due to movement or a change in orientation.

In response to identified movement or a change in orientation, either based on an analysis conducted directly at the AP or based on a comparison of received IMU and/or signal strength measurements with a model stored by the position monitoring system, a report can be generated including such data as detailed in relation to FIG. 4 at block 540. A report may only be generated if movement or a change in orientation is identified.

At block 550, the report is transmitted to a system or representative of the entity mapped to the AP at which the movement or change in orientation was detected. The entity can be responsible for the placement of the AP within a facility of the entity while functionality of the AP is controlled by the cellular network provider. In response to the report, a representative of the entity can adjust the location or orientation of the AP as needed to restore functionality.

Method 500 can be performed on behalf of multiple unrelated entities by the same cellular network core and position monitoring system such as detailed in relation to FIG. 2. Therefore, many distinct and unrelated entities can have small cells or, more generally, APs installed at their respective facilities, with the position and orientation of such APs monitored by the cellular network provider.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A cellular system, comprising:
an on-site small cell installation located at a facility of an entity, wherein the on-site small cell installation comprises:
a primary small cell that is configured to communicate, via a wired backhaul connection, with a cellular network core hosted by a cellular network provider; and
a secondary small cell comprising an inertial measurement unit (IMU), the secondary small cell configured to communicate:
via a cellular backhaul connection that uses a cellular communication protocol with the primary small cell; and
wirelessly with a plurality of user equipments (UEs) using the cellular communication protocol, wherein
the secondary small cell is configured to perform
movement measurements using the IMU; and
the on-site small cell installation is configured to transmit a first message based on the movement measurements to the cellular network core.

2. The cellular system of claim 1, wherein the on-site small cell installation is configured to measure a signal strength of the cellular backhaul connection and the on-site small cell installation is further configured to transmit a second message based on the signal strength to the cellular network core.

3. The cellular system of claim 2, further comprising a position monitoring system and the cellular network core, wherein the position monitoring system is configured to analyze the first message and the second message.

4. The cellular system of claim 3, wherein the position monitoring system and the cellular network core are executed on a cloud computing platform.

5. The cellular system of claim 3, wherein the position monitoring system is configured to generate a report that indicates an identifier of the secondary small cell and an indication of movement.

6. The cellular system of claim 3, wherein the position monitoring system is configured to generate a report that indicates an identifier of the secondary small cell and an indication of a change in orientation.

7. The cellular system of claim 1 further comprising:
a second on-site small cell installation located at a second facility of a second entity comprising:
a second primary small cell that is configured to communicate, via a second wired backhaul connection, with the cellular network core hosted by the cellular network provider; and
a second secondary small cell comprising a second IMU, the second secondary small cell configured to communicate:
via a second cellular backhaul connection with the primary small cell; and
wirelessly with a second plurality of UEs using the cellular communication protocol wherein
the second secondary small cell is configured to perform movement measurements using the second IMU; and
wherein the second on-site small cell installation is configured to transmit a second message based on the movement measurements using the second IMU to the cellular network core.

8. The cellular system of claim 1, wherein the cellular communication protocol is 5G New Radio (NR).

9. The cellular system of claim 3, wherein the position monitoring system is configured to build a position model for the secondary small cell over a period of time using data from the first message.

10. The cellular system of claim 3, wherein the position monitoring system is further configured to build a position model for the secondary small cell using signal strength data from the second message.

11. A method for monitoring indoor small cell displacement, comprising:
performing, by a secondary small cell, movement and orientation measurements, wherein:
the secondary small cell is configured to communicate via a cellular backhaul connection that uses a cellular communication protocol with a primary small cell; and
the secondary small cell is configured to wirelessly communicate with a plurality of user equipments (UEs) using the cellular communication protocol,
transmitting, by the secondary small cell, a message to a cellular network core based on the performed movement and orientation measurements;
in response to the message based on the performed movement and orientation measurements, generating, by a position monitoring system hosted with the cellular network core, a report indicative of displacement; and
transmitting, by the position monitoring system hosted with the cellular network core, the report to an entity mapped to the secondary small cell.

12. The method of claim 11, wherein performing the movement and orientation measurements comprises measuring a signal strength of the cellular backhaul connection.

13. The method of claim 11, further comprising:
analyzing, by the position monitoring system, the message received from the secondary small cell by comparing data from the message with a position model associated with the secondary small cell.

14. The method of claim 11, wherein the position monitoring system and the cellular network core are executed on a public cloud computing platform by a cellular network provider.

15. The method of claim 11, wherein the report indicates an identifier of the secondary small cell and an indication of a change in orientation.

16. The method of claim 11, further comprising:
performing, by a second secondary small cell, movement and orientation measurements, wherein:
the second secondary small cell is configured to communicate via a cellular backhaul connection that uses the cellular communication protocol with a second primary small cell;
transmitting, by the second secondary small cell, a second message to the cellular network core based on the performed movement and orientation measurements;
in response to the second message based on the performed movement and orientation measurements, generating, by the position monitoring system hosted with the cellular network core, a second report indicative of displacement; and
transmitting, by the position monitoring system hosted with the cellular network core, the report to a second entity mapped to the second secondary small cell, wherein the second entity is distinct from the entity.

17. The method of claim 11, wherein the cellular communication protocol is 5G New Radio (NR).

18. The method of claim 14, further comprising:
building, by the position monitoring system, is configured to build a position model for the secondary small cell over a period of time using data from the message.

19. The method of claim 18, wherein the position model is built using signal strength data.

20. A non-transitory processor-readable medium, comprising processor-readable instructions configured to cause one or more processors of a secondary access point to:
perform movement and orientation measurements comprising signal strength measurements of a cellular backhaul connection, wherein:
the secondary access point is configured to communicate via the cellular backhaul connection that uses a cellular communication protocol with a primary access point; and
wirelessly with a plurality of user equipments (UEs) using the cellular communication protocol; and
transmit a message to a cellular network core based on the performed movement and orientation measurements.
